(19) United States
(12) Patent Application Publication
(10) Pub. No.: US 2015/0371319 A1
(43) Pub. Date: Dec. 24, 2015

(54) PROVIDING VOICE DIRECTIONS TO A CUSTOMER WITHIN A STORE

(71) Applicant: Wal-Mart Stores, Inc., Bentonville, AR (US)

(72) Inventors: Stuart Argue, Palo Alto, CA (US); Anthony Emile Marcar, San Francisco, CA (US)

(21) Appl. No.: 14/313,506

(22) Filed: Jun. 24, 2014

(51) Int. Cl. G06Q 30/06

(52) U.S. Cl. CPC G06Q 30/0639; G06Q 30/0633

(57) ABSTRACT

The present invention extends to methods, systems, and computer program products for providing voice directions to a customer within a store. A store navigation server can contain a map of a store as well as the location of items for sale within the store. A mobile device can send a notification to the store navigation server to indicate when an item has been checked off of the mobile device shopping list or when the customer has just entered a store. In addition, the mobile device can send a next item to the store navigation server. The store navigation server can calculate step-by-step directions between the customer's approximate location and the next item. The store navigation server can format a route to the next item for audible presentation at the mobile device. The mobile device can process the formatted route to provide step-by-step voice directions to a customer.

### CROSS-REFERENCE TO RELATED APPLICATIONS

Not applicable.

### BACKGROUND

1. Field of the Invention

This invention relates generally to the field of navigation within a store, and, more particularly, to providing voice directions to a customer within a store.

2. Related Art

In a variety of scenarios related to consumer goods and/or retail products, consumers or buyers of goods may have a desire to purchase multiple items; either from one store or from multiple stores. In order to make sure the consumer does not forget the items they intend to buy, a common practice is to create a list itemizing the products or services the consumer is interested in purchasing. This list, commonly referred to as a shopping list, can be used to remind the consumer regarding which items the consumer intends to purchase.

A practice that is becoming more and more common is to create shopping lists in a digital format. For example, consumers can create shopping lists on their computer or on their mobile devices (e.g., smartphones). One advantage of having a shopping list on a mobile device is that the consumer is more likely to have their mobile device in their possession during the course of a day. As items come to the consumers mind, the consumer can add to or remove items from the shopping list on their mobile device. Furthermore, as the consumer goes shopping, the consumer can check items off of the shopping list as the items are retrieved.

In many cases, consumers may be new to a particular store or otherwise unfamiliar with a store layout. Consequently, the consumer may move through the store inefficiently in an effort to retrieve the items from their shopping list. For example, they may not know where items may be found within the store causing the consumer to wander through several aisles. Alternately, they may not know if the store carries the item that they are interested in purchasing; especially if the item they are interested in purchasing is a specialty item or needs to be from a specific manufacturer

### BRIEF DESCRIPTION OF THE DRAWINGS

The specific features, aspects and advantages of the present invention will become better understood with regard to the following description and accompanying drawings where:

FIG. 1 illustrates an example block diagram of a computing device.

FIG. 2 illustrates an example computer architecture that facilitates providing voice directions to a customer within a store.

FIG. 3 illustrates a flow chart of an example method for providing voice directions to a customer within a store.

### DETAILED DESCRIPTION

The present invention extends to methods, systems, and computer program products for providing voice directions to a customer within a store.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the invention can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (SaaS), Platform as a Service (PaaS), Infrastructure as a Service (IaaS), and deployment models (e.g., private cloud, community cloud, public cloud, hybrid cloud, etc.). Databases and servers described with respect to the present invention can be included in a cloud model.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

In this description and in the following claims, an “application ID” is defined as an identifier used to match a mobile device to a shopping list. An application ID can be a shopping list ID, a mobile device ID, an account ID, a session ID, a user name, an application specific ID, an ID from a device keychain, any other token as well as a combination of one of more of these.

In general, embodiments of the invention are directed to providing voice directions to a customer within a store. A store navigation server has access to a store layout (map) of the store. The store navigation server also has access to an item database. The item database associates items for sale at the store to their corresponding location within the store.

When a customer initially enters a store, an in store information technology infrastructure (e.g., a set of wireless access points) can detect that a mobile device is within range. Initially detecting a mobile device can be an indication that the mobile device (and thus also the customer) is near a store entrance. As such, a store navigation server can approximate the location of a customer as near (or at) a store entrance when a mobile device is initially detected. When a store has multiple entrances, the information technology infrastructure can determine which entrance the mobile device is at (e.g., WiFi triangulation, near field communicators, detecting wireless signal strength, etc.). Alternately, a customer can cause their mobile device to send a signal to a store navigation server indicating that they have just entered a store.

Mobile devices can include a shopping list management module. The shopping list management module can maintain a customer shopping list. When a customer first enters a store, the mobile device can use wireless communication to send a notification to the store navigation server. The notification can indicate customer location data (e.g. that the customer is at the store entrance) and the next item on the shopping list.

After the customer has entered the store and retrieves an item within the store, the customer can check off the item on the shopping list. In response to the customer checking off the item, the mobile device can use wireless communication to send a notification to the store navigation server. The notification can indicate the checked off item and the next item on the shopping list. In response to receiving a notification of a checked off item, the store navigation server can infer that the customer's approximate location is near the checked off item.

The shopping list management module can also send an application ID of the shopping list management module. The shopping list management module can also send additional item related data, such as, for example, an item IDs, an item types, and textual item descriptions.

Upon receiving the notification from the customer mobile device, the store navigation server can refer to an appropriate database and to a store layout (map) to infer the approximate location of the customer within the store and to determine the location of a next item within the store. When a received notification includes item IDs, the store navigation server can refer directly to the item database to obtain item locations. The store navigation server calculates a path from the customer's approximate location to the next item.

The store navigation server can formulate voice directions for guiding a customer along the path to the next item. The path can be from the store entrance (when the customer enters the store) to the next item or it can be from item to item (after the customer has entered the store and began to retrieve items). The voice directions can be sent via a wireless connection to the customer mobile device. The customer mobile device can receive the voice instructions. The customer mobile device can audibly present the voice directions to the customer utilizing audio capabilities of the customer mobile device, such as, for example, speakers or a headphone interface.

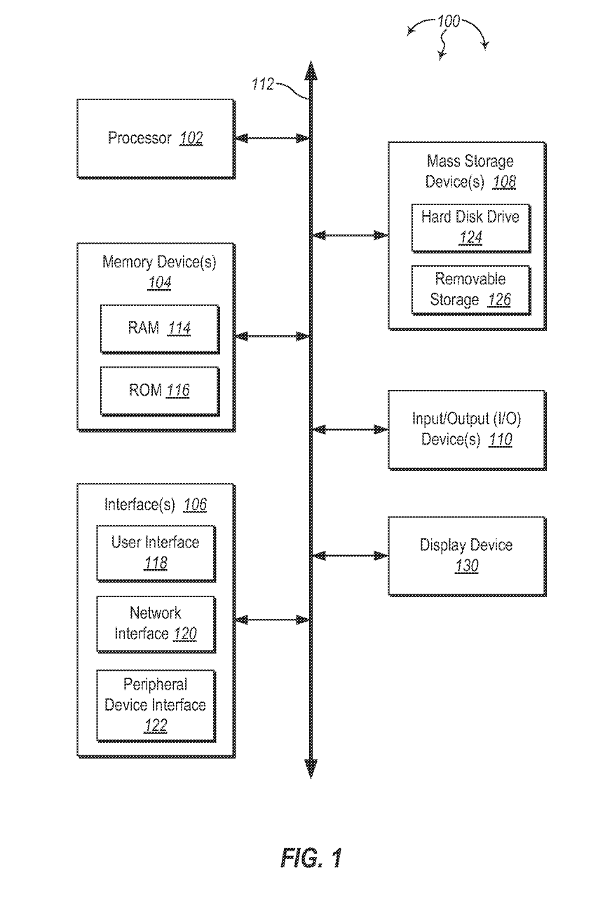

FIG. 1 illustrates an example block diagram of a computing device 100. Computing device 100 can be used to perform various procedures, such as those discussed herein. Computing device 100 can function as a server, a client, or any other computing entity. Computing device 100 can perform various communication and data transfer functions as described herein and can execute one or more application programs, such as the application programs described herein. Computing device 100 can be any of a wide variety of computing devices, such as a mobile telephone or other mobile device, a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer storage media, such as cache memory.

Memory device(s) 104 include various computer storage media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer storage media, such as magnetic tapes, magnetic disks, optical disks, solid state memory (e.g., Flash memory), and so forth. As depicted in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, barcode scanners, microphones, monitors or other display devices, speakers, printers, network interface cards, modems, cameras, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments as well as humans. Example interface(s) 106 can include any number of different network interfaces 120, such as interfaces to personal area networks (PANs), local area networks (LANs), wide area networks (WANs), wireless networks (e.g., near field communication (NFC), Bluetooth, Wi-Fi, etc, networks), and the Internet. Other interfaces include user interface 118 and peripheral device interface 122.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

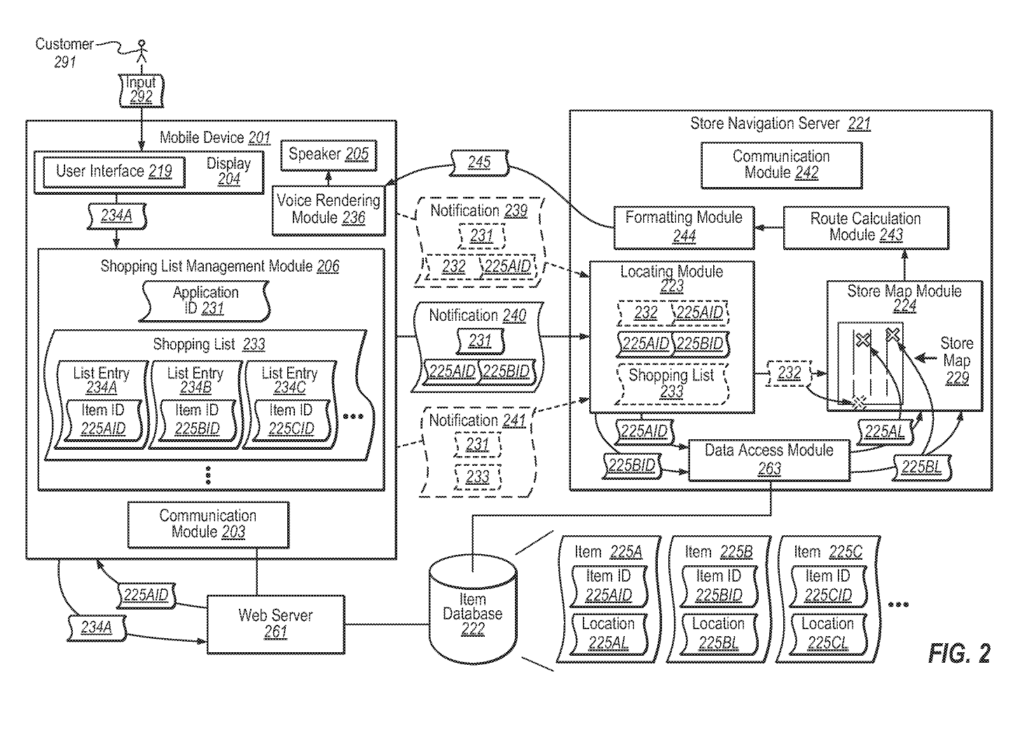

FIG. 2 illustrates an example computer architecture 200 that facilitates providing voice directions to a customer within a store. Referring to FIG. 2, computer architecture 200 includes mobile device 201, store navigation server 221, item database 222, and Web server 261. Each of mobile device 201, store navigation server 221, item database 222, and Web server 261 as well as their respective components can be connected to one another over (or be part of) a network, such as, for example, a PAN, a LAN, a WAN, and even the Internet. Accordingly, each of mobile device 201, store navigation server 221, item database 222, and Web server 261 as well as any other connected computer systems and their components, can create message related data and exchange message related data (e.g., near field communication (NFC) payloads, Bluetooth packets, Internet Protocol (IP) datagrams and other higher layer protocols that utilize IP datagrams, such as, Transmission Control Protocol (TCP), Hypertext Transfer Protocol (HTTP), Simple Mail Transfer Protocol (SMTP), etc.) over the network.

In general, store navigation server 221 is configured to provide voice directions to a customer mobile device. The voice directions can provide (e.g., step-by-step) instructions for navigating between items (locations) within a store. Store navigation server 221 includes communication module 242, formatting module 244, route calculation module 243, locating module 223, store map module 224, and database access module 263. Communication module 242 can be a wireless network adapter for connecting store navigation server 221 a wireless network, such as, for example, a WiFi network, within a store.

Locating module 223 is configured to determine the location of items within a store and also to infer the location of customers within a store. Locating module 223 can receive notifications of items on a shopping list, such as, for example, items checked off of a shopping list as well as additional items included on customer shopping lists (e.g., a next item on a shopping list). In some embodiments, locating module 223 is configured to determine a customer's approximate location within a store based on a notification that the customer has entered the store. For example, locating module 223 can receive indication 232 (e.g., from an in store information technology infrastructure) indicating when a customer has entered a store. Locating module 223 can approximate that the customer location is near an entrance to the store.

Locating module 223 can also refer to item database 222 (through database access module 263) to identify a customer's approximate location by referencing the location for an item checked off of a customer shopping list. Locating module 223 can also refer to item database 222 (through database access module 263) to identify a location of the next item on a shopping list. Store map module 224 can then identify the item locations on map 229. Store map module 224 can send the customer's approximate location and the location of the next item to route calculation module 243.

Given the customer's approximate location and the next item location, route calculation module 243 can generate a route from the customer's approximate location to the location the of next item location. Route calculation module 243 can send a determined route to formatting module 244. Formatting module 244 can formulate voice directions for instructing a customer how to move within the store from the customer's approximate location to the location of the next item. The voice directions can be sent to a mobile device for presentation to a customer.

Store map module 224 can maintain store map 229 (or layout) of the store, including, but not limited to, the number and location of aisles, the location of point of sale systems, the location of departments, etc. Database access module 263 is configured to maintain (e.g., access, store, update, etc.) data in item database 222. Item database 222 can contain item information, including item name, item description, item ID, and item location information (i.e., where the item is located in the store) for items within the store.

For example, item database 222 can include item information for items 225A, 225B, and 225C. Item information for item 225A includes item ID 225AID and location 225AL (the location of item 225A within the store). Item information for item 225B includes item ID 225BID and location 225BL (the location of item 225B within the store). Item information for item 225C includes item ID 225CID and location 225CL (the location of item 225C within the store).

Mobile device 201 (e.g., a smartphone) includes communication module 203, display 204, speaker 205, voice rendering module 236, and shopping list management module 206. Generally, shopping list management module 206 is configured to manage shopping list data for a user of mobile device 201 (e.g., customer 291). Shopping list management module 206 can be used to perform shopping list related operations, such as, for example, adding shopping list items, checking off shopping list items, removing shopping list items, sorting shopping list items, searching shopping list items, itemizing shopping list items, etc. in response to user-entered commands. Shopping list management module 206 is also associated with application ID 231. Application ID 231 can be a unique ID used to distinguish shopping list management module 206 (and thus also mobile device 201) from other shopping list management modules (and thus also from other mobile devices). Application ID 231 can be assigned to mobile device 201 or derived from user related information, such as, for example, a telephone number, a loyalty card number, etc.

Shopping list management module 206 can present user-interface 219 at display 204 (e.g., a general purpose display device). User-interface 219 can include (e.g., touch screen) user-interface controls allowing a user to enter shopping list data and manipulate shopping list data. A user can enter input at user interface 219 to add items to the shopping list, sort the shopping list, check items off of the shopping list, etc. For example, customer 291 can enter input 292 to create shopping list 233. As depicted, shopping list 233 includes list entries 234A, 234B, 234C, etc. including item IDs 225AID, 225BID, 225CID, etc., respectively. Item IDs 225AID, 225BID, 225CID correspond to items 225A, 225B, and 225C in item database 222.

Speaker 205 can output audio data including voice directions for moving between locations within a store. The audio output may also be transmitted using a mobile device headphone interface.

Shopping list management module 206 can also send notifications to store navigation server 221 when the customer has first entered a store and detected a wireless network, or when shopping list entries have been checked off of or added to shopping list 233. For example, notification 239 can include the application id 231, an indication that the customer has just entered the store 232, and the next item ID on the customer shopping list 225AID. Shopping list management module 206 can also send notification 240 which can include the application id 231, the item that was checked off of the shopping list 225AID, and for a next item from the shopping list 225BID.

Voice rendering module 236 is configured to receive input in the form of text files, audio files, etc. for presentation to customer 291 in audible format. Voice rendering module 236 can utilize the capabilities of mobile device 201, such as, for example, speaker 205 or a headphone interface

Communication module 203 can be a wireless network adapter for connecting mobile device 201 with a wireless network, such as, for example, Wi-Fi and/or a cellular network (e.g., CDMA, GSM, iDen, etc.) that facilitates a further connection to a network (e.g., the Internet).

Mobile device 201 can also access web server 261 which has access to item database 222. Web server 261 can be used to identify item IDs corresponding to items on shopping list 233. Alternatively, web server 261 can notify customer 291 if items on shopping list 233 cannot be located in item database 222.

A mobile device user can use Web server 261 to resolve list entries. For example, mobile device 201 can send a generic item (textual) description to Web server 261. Web server 261 can attempt to identify an appropriate item ID form item database 222. For example, mobile device 201 can submit list entry 234A to Web server 261. Web server 261 can determine that list entry 234A corresponds to item 225A. As such, Web server 261 can return item ID 225AID to mobile device 201. Mobile device 201 can then use item ID 225AID when sending notifications to store navigation server 221.

In some embodiments, an entire shopping list can be transmitted from a mobile device to store navigation server 221 upon a customer entering the store. Store navigation server 221 can cache the shopping list. Store navigation server 221 can preprocess the shopping list to identify item locations within store map 229. Thus, when a notification of a checked off item is received, customer locating module 223 can more quickly determine a customer's location. For example, shopping list management module 206 can send notification 240 to the store navigation server. Notification 240 can include application ID 231 and the entire shopping list 233.

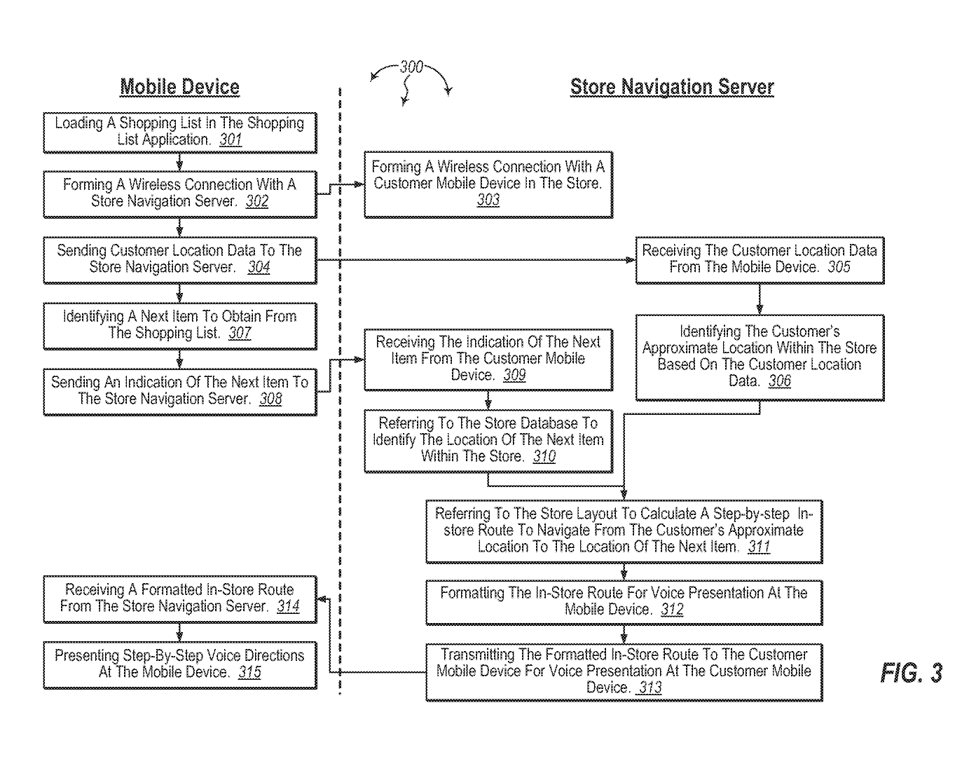

FIG. 3 illustrates a flow chart of an example method 300 for providing voice directions to a customer within a store. Method 300 will be described with respect to the components and data of computer architecture 200.

Method 300 includes loading a shopping list in the shopping list application, the shopping list containing a list of items of interest to the customer (301). For example, customer 291 can enter input 292 to load shopping list 233 in shopping list management module 206. Once shopping list 233 has been created, customer 291 can add items to shopping list 233, or remove items from shopping list 233 via user interface 219. For example, through user interface 219, customer 291 can add items 234A, 234B, 234C, etc. to shopping list 233.

In some embodiments, customer 291 can create shopping list 233, or add items to shopping list 233 via a web interface. For example, customer 291 may have created shopping lists on a computer at home or at work and uploaded the list to a web server, such as, for example, web server 261. Customer 291 can then download shopping list 233 from web server 261 to mobile device 201.

Method 300 includes forming a wireless connection with a store navigation server (302). Method 300 includes forming a wireless connection with a customer mobile device in the store, the customer mobile device maintaining a shopping list for a customer, the shopping list including a list of items of interest to the customer (303). For example, mobile device 201 and store navigation server 221 can form a wireless connection with one another. In some embodiments, after forming a wireless connection, shopping list management module 206 sends notification 241, including application ID 231 and shopping list 233 to store navigation server 221. Upon receiving shopping list 233, store navigation server 221 can cross-reference each item on shopping list 233 with store item database 222. This can facilitate faster processing for generating directions when the customer checks an item off of shopping list 233. In addition, in some embodiments, the store navigation server can generate a route for the entire shopping list 233 as opposed to generating a route between two items (or two locations).

Method 300 includes sending customer location data to the store navigation server (304). Method 300 includes receiving the customer location data from the customer mobile device (305). For example, in some embodiments, when mobile device 201 first detects a store wireless network, mobile device 201 can send notification 239 which includes application ID 231, indication 232, and item id 225AID. Indication 232 indicates that the customer is at a store entrance. If the store has more than one entrance, techniques such as, for example, WiFi triangulation or near field communicators can be used to determine the appropriate entrance. In other embodiments, shopping list management module can send notification 240 which includes application ID 231 and item IDs 225AID and 225BID. Notification 240 can occur when shopping list management module 206 checks list entry 234A off of shopping list 233. Checking off list entry 234A indicates that the item 225A has been obtained.

Also, in response checking off list entry 234A, mobile device 201 and/or store navigation server 221 can optionally infer that customer 291 has taken possession of item 225A.

Method 300 includes identifying the customer's approximate location within the store based on the customer location data (306). For example, in some embodiments, store navigation server 221 can receive customer location 239 indicating that the customer's approximate location is at a store entrance. In other embodiments, shopping list management module 206 can receive input 292 for checking off list entry 234A. Customer 291 can enter input 292 subsequent to physically retrieving an item (e.g., item 225A) within the store. Mobile device 201 can send notification 240 which includes application ID 231, item ID 225AID, and item ID 225BID (which is the item ID of the next item).

Locating module 223 can approximate that the customer location is near the location of item 225A (based on corresponding item ID 225AID). For example, item locating module 223 can pass item ID 225AID to database access module 263. Item locating module 223 can utilize database module 263 to access item database 222. Item locating module 223 can refer to item database 222 to determine that item ID 225AID corresponds to item 225A. Furthermore, item locating module 223 can refer to item database 222 to determine that item 225A is located at location 225AL. Database access module 263 can pass location 225AL to store map module 224. Store map module 224 can identify location 225AL on store map 229.

Method 300 includes identifying a next item to obtain from the shopping list (307). For example, shopping list management module 206 can identify another item on the shopping list to be sent to the store navigation server 221 as part of notification 240. The item may be the next sequential item, item 234B, or it may be an item that is determined to be in close proximity to item 234A. This determination may be made by utilizing information obtained from item database 222 via web server 261 previously. In some embodiments, the next item may be manually selected by customer 291 via input 292.

Method 300 includes sending an indication of the next item to the store navigation server 221, the indication indicating the next item to obtain from the shopping list (308). Method 300 includes receiving the indication of the next item from the customer mobile device (309). For example, in response to list entry 234A being checked off of shopping list 233, shopping list management module 206 can send notification 240 to store navigation server 221. Notification 240 includes application ID 231, item ID 225AID, and item ID 225BID. Application ID 231 identifies mobile device as the sender of the notification. Item ID 225AID indicates the item 225A was checked off of shopping list 233. Item ID 225BID indicates that item 225B is the next item from shopping list 233 that the customer intends to obtain. Store navigation server 221 can receive notification 240, including application ID 231, item ID 225AID, and item 225BID, from mobile device 201.

Alternately, notification 239 can indicate that a customer is at a store entrance and that item 225A (as identified by id 225AID) is the next item.

Method 300 includes referring to the store database to identify the location of the next item within the store (310). For example, when receiving notification 240, item locating module 223 can pass item ID 225BID to database access module 263. Item locating module 223 can utilize database module 263 to access item database 222. Item locating module 223 can refer to item database 222 to determine that item ID 225BID corresponds to item 225B. Furthermore, item locating module 223 can refer to item database 222 to determine that item 225B is located at location 225BL. Database access module 263 can pass location 225BL to store map module 224. Store map module 224 can identify location 225BL on store map 229.

Alternately, when receiving notification 239, item locating module 223 can pass item ID 225AID to database access module 263. Item locating module 223 can utilize database module 263 to access item database 222. Item locating module 223 can refer to item database 222 to determine that item ID 225AID corresponds to item 225A. Furthermore, item locating module 223 can refer to item database 222 to determine that item 225A is located at location 225AL. Database access module 263 can pass location 225AL to store map module 224. Store map module 224 can identify location 225AL on store map 229.

Method 300 includes referring to the store layout to calculate a step-by-step in-store route to navigate from the customer's approximate location to the location of the next item (311). For example, route calculation module 243 can utilize item location 225AL (or store entrance location 232), item location item 225BL (or item location 225AL), and store map 229 (all from store map module 224) to determine a path from location 225AL to location 225BL (or from store entrance location 232 to item 225A). In some embodiments, route calculation module 243 can use various routing or navigation algorithms to determine an optimal route, in an effort to minimize the time it takes the customer to go from location 225AL to location 225BL (or from a store entrances to item 225A). In addition, in some embodiments, visual directions (e.g. in the form of a digital map) may be generated for transmission to the mobile device to accompany the step-by-step audible directions.

Method 300 includes, formatting the in-store route for voice presentation at the mobile device (312). For example, formatting module 244 can take the route that was generated by route calculation module 243 and format the route in such a fashion that the formatted route 245 can be sent to the customer mobile device 201 and presented audibly to customer 291. In some embodiments, the format may be a text format which can be understood and audibly presented by an audio application native at the customer mobile device. In other embodiments, the formatting module may convert the in-store route to an audio file at the store navigation server. Example audio file formats can be uncompressed audio formats, such as WAV, AIFF, AU, or raw header-less PCM; formats with lossless compression, such as FLAC, APE, WavPack, TTA, ATRAC, m4a, MPEG-4 SLS, MPEG-4 ALS, MPEG-4 DST, WMA, and SHN, or formats with lossy compression, such as MP3, Vorbis, Musepack, AAC, ATRAC, and WMA lossy.

Method 300 includes, in response to the received notification, transmitting the formatted in-store route to the customer mobile device for voice presentation at the customer mobile device (313). Method 300 includes receiving a formatted in-store route from the store navigation server (314). For example, store navigation server 221 can send formatted input 245 to mobile device 201. Mobile device 201 can receive formatted input 245 from store navigation server 221. Formatted input 245 can include data in one or more formats, such as, for example, text files, audio files, etc. that can be presented audibly at mobile device 201. Formatted input 245 can be forwarded to voice rendering module 236.

Method 300 includes presenting step-by-step voice directions at the mobile device (315). For example, voice rendering module 236 can process formatted input 245 to audibly present the step-by-step directions to customer 291 utilizing the mobile device audio capabilities such as, for example, speaker 205 or through a headphone interface.

By allowing store navigation server 221 to access shopping list management module 206 and to create step-by-step directions to the various items contained within shopping list management module 206, a customer can be provided an efficient route to obtain items on a shopping list. This increase in efficiency can result in time savings to the customer, increased shopping satisfaction to the customer, potential savings to the customer (by helping the customer to focus only on items on their shopping list and not buy additional items) and an overall better quality of experience to the customer.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

The foregoing description has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the invention.

Further, although specific embodiments of the invention have been described and illustrated, the invention is not to be limited to the specific forms or arrangements of parts so described and illustrated. The scope of the invention is to be defined by the claims appended hereto, any future claims submitted here and in different applications, and their equivalents.

What is claimed:

1. At a store navigation server for a store, the store navigation server including one or more processors and system memory, the store navigation server maintaining a layout for a store, the store navigation server able to communicate with a database server for the store, the database server maintaining the location of items within the store, the store navigation server able to communicate with customer mobile devices in the store via a wireless connection, a method for providing voice directions to the customer mobile device, the voice directions directing the customer within the store to the location of items on the customer shopping list, the method comprising:
forming a wireless connection with a customer mobile device in the store, the customer mobile device maintaining a shopping list for a customer, the shopping list including a list of items of interest to the customer;
receiving the customer location data from the mobile device, the customer location data indicating whether the customer is at a store entrance or whether the customer has retrieved an item from their shopping list
identifying the customer's approximate location within the store based on the customer location data;
receiving the indication of the next item from the customer mobile device, the next item being selected manually by the customer or automatically by the customer mobile device;
referring to the store database to identify the location of the next item within the store;
referring to the store layout to calculate a step-by-step in-store route to navigate from the customer's approximate location to the location of the next item;
formatting the in-store route for voice presentation at the mobile device; and
transmitting the formatted in-store route to the customer mobile device for voice presentation at the customer mobile device.

2. The method of claim 1, further comprising transmitting visual directions for display at the customer mobile device.

3. The method of claim 1, wherein a route is generated from the store entrance to an item on the customer shopping list.

4. The method as recited in claim 1, further comprising:
receiving a copy of the shopping list from the customer mobile device; and
in response to receiving the copy of the shopping list, determining the location of the items on the shopping list within the store.

5. The method of claim 4, calculating a route within the store to the location of all of the items on the shopping list.

6. The method of claim 5, further comprising calculating the optimal shopping route within the store to the location of all of the items on the shopping list.

7. The method of claim 4, further comprising, subsequent to receiving a copy of the shopping list, receiving a notification from the customer mobile device that an additional item has been added to the shopping list.

8. The method of claim 1, wherein the directions to be transmitted to the mobile device are in a text format; the text format to be subsequently converted to an audio format at the customer mobile device.

9. The method of claim 1, wherein the directions to be transmitted to the mobile device are in an audio format.

10. The method of claim 1, wherein the voice directions are generated in a language dependent on the customer preferences.

11. At a mobile device, the mobile device including one or more processors and system memory, the mobile device containing a shopping list application, the shopping list application configured to manage shopping lists for a customer, the mobile device able to communicate with other computer systems via a wireless connection, a method for providing voice directions to shopping list item within a store, the method comprising:
loading a shopping list in the shopping list application, the shopping list containing a list of items of interest to the customer;
forming a wireless connection with a store navigation server for the store;
sending customer location data to the store navigation server, the customer location data indicating whether the customer is at the store entrance or whether the customer has retrieved an item from their shopping list;
identifying a next item to obtain from the shopping list, the next item being manually selected or automatically selected;
sending an indication of the next item to the store navigation server;
receiving a formatted in-store route from the store navigation server, the in-store route indicating how to move through the store to get from the customer's approximate location to the location of the next item; and
presenting step-by-step voice directions at the mobile device, the step-by-step voice directions for navigating the in-store route.

12. The method of claim 11, wherein the mobile device can receive directions in text format and utilize a voice rendering module resident at the mobile device to convert the text base directions to audio directions.

13. The method of claim 11, wherein the mobile device can receive directions in audio format and play the directions at the mobile device.

14. The method of claim 11, further comprising receiving visual directions to accompany the audio directions for display at the customer mobile device, the visual directions including:
a map of the store layout and an indication of the item locations in reference to the store layout;
a recommended path to follow that leads from one item to the next item.

15. The method of claim 11, wherein an entire shopping list contained within the shopping list application resident at the customer mobile device can be sent to the store navigation server.

16. The method of 15, further comprising, subsequent to sending the shopping list to the store navigation server, sending a notification from the customer mobile device that an additional item has been added to the shopping list or that an item has been deleted from the customer shopping list.

17. The method of claim 11, wherein the voice directions can be in a language of the customer choosing.

18. The method of claim 11, wherein the voice directions can be accompanied by textual subtitles.

19. A system for providing voice directions, the voice directions directing a customer within a store to the location of items on the customer shopping list, the system comprising: a store navigation server and a mobile device,
the store navigation server comprising:
one or more processors;
system memory;
a network adapter;
one or more computer storage media having stored thereon computer-executable instructions that, when executed, cause the store navigation server to:
form a wireless connection with the customer mobile device in the store, the customer mobile device maintaining a shopping list for a customer, the shopping list including a list of items of interest to the customer;
receive the customer location data from the customer mobile device, the customer location data indicating whether the customer is at a store entrance or whether the customer has retrieved an item from their shopping list;
identify the customer's approximate location within the store based on the customer location data;
receive the indication of the next item from the customer mobile device;
refer to the store database to identify the location of the next item within the store;
refer to the store layout to calculate a step-by-step in-store route to navigate from the customer's approximate location to the location of the next item;
format the in-store route for voice presentation at the mobile device; and
transmit the formatted in-store route to the customer mobile device for voice presentation at the customer mobile device; and
the mobile device comprising:
one or more processors;
system memory;
a network adapter;
one or more computer storage media having stored thereon computer-executable instructions that, when executed, cause the mobile device to:
load a shopping list in a shopping list application, the shopping list containing a list of items of interest to the customer;
form a wireless connection with the store navigation server for the store;
send customer location data to the store navigation server, the customer location data indicating whether the customer is at the store entrance or whether the customer has retrieved an item from their shopping list;
identify a next item to obtain from the shopping list, the next item being manually selected or automatically selected; and
send an indication of the next item to the store navigation server;
receive a formatted in-store route from the store navigation server, the in-store route indicating how to move through the store to get from the customer's approximate location to the location of the next item; and
presenting step-by-step voice directions at the mobile device, the step-by-step voice directions for navigating the in-store route.

20. The system of claim 19, wherein computer-executable instructions that, when executed, cause the store navigation server to receive an indication of the next item comprise computer-executable instructions that, when executed, cause the store navigation server to receive a notification including an application ID for the mobile device and at least one of: an item ID, an item type, or a textual description of an item.
